(19) United States
(12) Patent Application Publication
(10) Pub. No.: US 2026/0177507 A1
(43) Pub. Date: Jun. 25, 2026

(54) VISUAL ON-LINE MEASURING DEVICE FOR INNER PIPE CROSS-SECTION DISTORTION DURING BENDING OF METAL PIPE WITH VARIABLE DIAMETER

(71) Applicant: ZHEJIANG UNIVERSITY, Hangzhou (CN)

(72) Inventors: Zili Wang, Hangzhou (CN); Xinlei Hu, Hangzhou (CN); Shuyou Zhang, Hangzhou (CN); Jianrong Tan, Hangzhou (CN)

(21) Appl. No.: 19/415,609

(22) Filed: Dec. 10, 2025

(30) Foreign Application Priority Data
Dec. 23, 2024 (CN) 202411898067.1

(51) Int. Cl. G01N 21/954

(52) U.S. Cl. CPC G01N 21/954; G01N 2201/06113

(57) ABSTRACT

A visual on-line measuring device for inner pipe cross-section distortion during bending of metal pipe with variable diameter. The visual on-line measuring device includes: a visual inspection module, a hose, an in-pipe support device, and an axial feeding device. The hose is mounted in the axial feeding device, one end of the hose extends out of the axial feeding device and is mounted with the in-pipe support device, and the visual inspection module is mounted at one side of the in-pipe support device away from the axial feeding device.

### CROSS-REFERENCE TO RELATED APPLICATION

This application claims priority of Chinese Patent Application No. 202411898067.1, filed on Dec. 23, 2024, the entire contents of which are incorporated herein by reference.

### TECHNICAL FIELD

The present disclosure belongs to the field of pipe fitting bending and forming, relates to a measuring device for inner pipe cross-section distortion of metal pipe fittings, and in particular to a visual on-line measuring device for inner pipe cross-section distortion during bending of metal pipe with variable diameter.

### BACKGROUND

Due to the hollow cross-section geometric structure of the metal conduit, when the metal conduit bends in a certain direction under the action of external bending moment and load, the regular shape and size of the original cross-section of the metal conduit will inevitably be disrupted, causing the pipe diameter to change non-uniformly along the circumferential direction of the cross-section, resulting in cross-sectional flattening distortion. This not only weakens the rigidity of the cross-section but further causes pressure loss and flow pulsation of the conveyed fluid. On-line measurement of cross-section flattening distortion defects is of great significance to accurately intervene in the bending and forming process of metal conduit and improve the forming quality.

Due to the limitation of detection means, the shape detection and accurate characterization of pipe cross-section in the forming process cannot be effectively implemented at the bending production site, resulting in preliminary tests and repeated trial-and-error bending for different pipe fittings in the actual production process, which hinders the effective prediction and compensation of cross-section distortion. Moreover, relative to the outer side wall, the cross-section distortion of the inner side wall of the pipe has a direct impact on the accuracy of transporting precise fluid, and it is difficult to measure the distortion of the inner wall in the case of small pipe diameter and narrow space.

In view of the above problems, some people have provided the solution of pipeline endoscopic robot. However, the existing solutions have problems such as being only applicable to formed pipe fittings and unable to be used in the bending process, relying solely on a monocular camera which fails to achieve the measurement objective, and being difficult to integrate multiple functions including variable diameter, feeding, and measurement in the case of small pipe diameters.

### SUMMARY

To solve the problems in the background, the present disclosure provides a visual on-line measuring device for inner pipe cross-section distortion during bending of metal pipe with variable diameter, which is used for time series measurement of cross-section distortion of pipe inner wall bending forming of pipe fittings with different diameters, and has great significance for subsequent real-time optimization of bending pipe fitting processing technology.

The technical solutions adopted by the present disclosure are as follows.

A visual on-line measuring device for inner pipe cross-section distortion during bending of metal pipe with variable diameter includes a visual inspection module, a hose, an in-pipe support device, and an axial feeding device. The hose is mounted in the axial feeding device, one end of the hose extends out of the axial feeding device and is mounted with the in-pipe support device, and the visual inspection module is mounted at one side of the in-pipe support device away from the axial feeding device.

The visual inspection module includes a laser and an endoscope, the laser and the endoscope are mounted at one side of the in-pipe support device away from the axial feeding device.

The in-pipe support device includes a variable-diameter sliding bar mechanism and spring locking mechanisms, the variable-diameter sliding bar mechanism is fixedly connected to the one end of the hose extending out of the axial feeding device, the visual inspection module are fixedly mounted on an end face of the variable-diameter sliding bar mechanism away from the axial feeding device, and a number of locking sliding bars of the variable-diameter sliding bar mechanism are mounted with corresponding spring locking mechanisms.

The variable-diameter sliding bar mechanism includes an inner ring shaft, a first sliding block disc, a second sliding block disc, a cam disc, a first limit retaining ring, a stepped retaining ring, an end cover, a first bearing, a number of sliding bars, a number of locking sliding bars, serpentine springs, plug pins, universal wheel connectors, and universal wheels; the visual inspection module is mounted on an end face of the inner ring shaft away from the axial feeding device, and the one end of the hose extending out of the axial feeding device is connected to an end face of the inner ring shaft close to the axial feeding device; the cam disc is coaxially sleeved outside a middle part of the inner ring shaft through the first bearing, and the first sliding block disc and the second sliding block disc are coaxially and fixedly connected to the inner ring shaft on two sides of the cam disc; a number of sliding bars arranged at intervals along a circumference are mounted on an outer circumferential side face of the first sliding block disc, a number of locking sliding bars arranged at intervals along the circumference are mounted on an outer circumferential side face of the second sliding block disc, and one of the spring locking mechanisms is mounted at one of a number of locking sliding bars; and a number of arc-shaped through grooves are disposed on an end face of the cam disc, one of the serpentine springs is mounted in each arc-shaped through groove, each plug pin sequentially penetrates through a middle part of the corresponding sliding bar of the first sliding block disc, the corresponding arc-shaped through groove of the cam disc, and a middle part of the corresponding locking sliding bar of the second sliding block disc, the rotation of the cam disc simultaneously drives all the sliding bars and locking sliding bars to move radially and synchronously, and a corresponding universal wheel is mounted at an end of each sliding bar/locking sliding bar through a corresponding universal wheel connector.

The spring locking mechanisms include a buckle; a side face of each locking sliding bar is disposed with a locking sliding bar special-shaped sliding groove, one end of the buckle is rotatably mounted on an outer circumferential side face of a second sliding block disc in a clearance fit manner, the other end of the buckle is arranged with a boss that is inserted into the locking sliding bar special-shaped sliding groove, and realizes guiding sliding along the locking sliding bar special-shaped sliding groove; and when the buckle is positioned at a bottom of the locking sliding bar special-shaped sliding groove, the locking sliding bar is in a maximum variable diameter position, and when the buckle is positioned at a top of the locking sliding bar special-shaped sliding groove, each locking sliding bar is in a minimum variable diameter position.

The locking sliding bar special-shaped sliding groove is a special-shaped ring groove, a top of an outer edge of the special-shaped ring groove is arranged with an inward protrusion, a top of an inner edge of the special-shaped ring groove is also arranged with an inward protrusion, the protrusion on the top of the outer edge and the protrusion on the top of the inner edge are staggered in a circumferential direction, the buckle is locked by the protrusion on the top of the inner edge when the buckle is located at a top of the special-shaped ring groove, and moves in the special-shaped ring groove according to a preset direction when the buckle is out of a locked state; and a middle of a bottom of an inner edge of the special-shaped ring groove is arranged with an upward inclined guide edge, the buckle moves upward along the guide edge, and moves in the special-shaped ring groove according to the preset direction.

The axial feeding device includes a bidirectional limit mechanism, a knob, an internal gearbox and a straight handle; the internal gearbox is mounted in the straight handle, the knob is arranged at a straight handle end cover of the straight handle, and the knob is coaxially and fixedly connected to a driving shaft of the internal gearbox; the internal gearbox is connected to the hose for driving the hose; and the bidirectional limit mechanism is mounted on an end face of the straight handle to adjustably limit the knob.

The internal gearbox includes a driving synchronous wheel, a driven synchronous wheel, a synchronous belt, an intermediate transmission shaft, a driven shaft, a first driven bevel gear, a second driven bevel gear, a driving bevel gear, a first drive gear, a second drive gear, the driving shaft, a second bearing, a third bearing, and a fourth bearing; the driving shaft is mounted in the straight handle end cover of the straight handle through the fourth bearing, one end of the driving shaft extends out of the straight handle end cover and is coaxially and fixedly connected to the knob, and the other end of the driving shaft is coaxially connected to the driving bevel gear; the intermediate transmission shaft and the driven shaft are arranged in the straight handle, the intermediate transmission shaft and the driven shaft are arranged in parallel and at intervals, the driven synchronous wheel and the second drive gear are coaxially sleeved outside the driven shaft, and an axial direction of the intermediate transmission shaft is arranged vertically with an axial direction of the driving shaft; the first driven bevel gear and the second driven bevel gear are coaxially sleeved at the intermediate transmission shaft on two sides of the driving bevel gear, respectively, the first driven bevel gear and the second driven bevel gear are both meshed with the driving bevel gear to form a bevel gear pair, the first driven bevel gear is coaxially and fixedly connected to the intermediate transmission shaft, and the second driven bevel gear is connected to the intermediate transmission shaft through the third bearing; the first drive gear is coaxially and fixedly connected to the intermediate transmission shaft close to the first driven bevel gear; the hose is arranged between the first drive gear and the second drive gear, annular teeth are arranged outside the hose, and the hose is oppositely meshed with the first drive gear and the second drive gear to form a driving pair; and the driving synchronous wheel is coaxially sleeved outside a rotating shaft of the second driven bevel gear, the driving synchronous wheel is coaxially and fixedly connected to the rotating shaft of the second driven bevel gear, and the driving synchronous wheel is connected to the driven synchronous wheel through the synchronous belt.

The internal gearbox further includes a triangular support structure, a seventh bearing, a sixth bearing and a fifth bearing; the triangular support structure is mounted between a shaft side of the driving shaft and a shaft side of the first driven bevel gear, and the triangular support structure is further mounted between the shaft side of the driving shaft and a shaft side of the second driven bevel gear; and an annular structure of the triangular support structure close to the driving bevel gear is connected to the shaft side of the driving shaft through the fifth bearing, an annular structure of the triangular support structure close to the second driven bevel gear is connected to the shaft side of the second driven bevel gear through the seventh bearing, and an annular structure of the triangular support structure close to the first driven bevel gear is connected to the shaft side of the first driven bevel gear through the sixth bearing.

The bidirectional limit mechanism includes a limit gear, a limit handle, a limit connecting bar, a limit spring and a limit optical shaft; the straight handle end cover is arranged with a straight handle end cover inner ring baffle and a straight handle end cover outer ring baffle, the limit gear is coaxially sleeved outside the driving shaft, and the limit gear is coaxially and fixedly connected to the driving shaft; the straight handle end cover is fixedly mounted with the limit optical shaft, one end part of the limit handle and one end part of the limit connecting bar is rotatably mounted in the limit optical shaft, and the limit handle and the limit connecting bar are arranged at an included angle; and a toothed end part of the limit handle is connected to the other end part of the limit connecting bar through the limit spring, the limit connecting bar is mounted on a circumferential side face of the straight handle end cover inner ring baffle, the straight handle end cover inner ring baffle is configured for limiting the limit connecting bar, and the limit handle is mounted on a circumferential side face of the limit gear for limiting the limit gear.

The present disclosure has the following advantageous effects.
(1) In the present disclosure, the on-line measurement of the cross-section distortion of the inner wall of a small diameter pipe is realized by measuring the time series data of the inner wall distortion of the pipe in the bending process with an endoscope and a laser.
(2) In the present disclosure, the diameter of the endoscope device can be adaptively changed by adjusting the cam sliding block with a spring, which can be used for bending and forming pipe fittings with different diameters.
(3) In the present disclosure, the axial change of the endoscope device is realized through the gearbox, the axial movement of the visual measuring mechanism in the pipe is realized, and the measurement information of different sections is obtained.
(4) The present disclosure has the advantages of simple structure and convenient adjustment, the axial position of the device in the pipe can be adjusted by rotating the knob of the gearbox, and the adjustment process is simple.

### BRIEF DESCRIPTION OF THE DRAWINGS

FIG. 1 is a schematic diagram of an overall structure of a measuring device according to the present disclosure.

FIG. 2 is a schematic structural diagram of an in-pipe support device according to the present disclosure.

FIG. 3A is an axial side view I of the in-pipe support device.

FIG. 3B is an axial side view II of the in-pipe support device.

FIG. 4A is a cross-sectional view I of the in-pipe support device.

FIG. 4B is a cross-sectional view II of the in-pipe support device.

FIG. 5 is a schematic structural diagram of a spring locking mechanism.

FIG. 6 is a schematic diagram of an overall structure of an internal gearbox.

FIG. 7A is a partial structural cross-sectional view I of the internal gearbox.

FIG. 7B is a three-dimensional axial side view of a triangular support structure.

FIG. 8 is a partial structural cross-sectional view II of the internal gearbox.

FIG. 9 is a schematic diagram of an overall structure of a bidirectional limit mechanism according to the present disclosure.

FIG. 10 is a schematic operation diagram of a visual inspection module according to the present disclosure.

FIG. 11A is a schematic diagram of a maximum variable diameter position of a variable-diameter sliding bar mechanism.

FIG. 11B is a schematic diagram of a minimum variable diameter position of the variable-diameter sliding bar mechanism.

FIG. 12A shows a locking state of the spring locking mechanism under the maximum diameter variation.

FIG. 12B shows a locking state of the spring locking mechanism under the minimum diameter variation.

FIG. 13A is a schematic diagram of a locking state of a bidirectional limit mechanism.

FIG. 13B is a schematic diagram of an opened state of the bidirectional limit mechanism.

FIG. 14 is a schematic diagram of the in-pipe support device in a curved pipe according to the present disclosure.

Reference numerals and denotations thereof: 1-visual inspection module; 2-in-pipe support device; 3-axial feeding device; 4-variable-diameter sliding bar mechanism; 5-spring locking mechanism; 6-bidirectional limit mechanism; 7-internal gearbox; 8-straight handle; 9-straight handle positioning pin hole; 10-straight handle geometric central shaft hole; 11-laser; 12-endoscope; 13-inner ring shaft; 14-first sliding block disc; 15-second sliding block disc; 16-cam disc; 17-first limit retaining ring; 18-stepped retaining ring; 19-end cover; 20-hose; 21-first bearing; 22-sliding bar; 23-locking sliding bar; 24-locking sliding bar special-shaped sliding groove; 25-serpentine spring; 26-plug pin; 27-universal wheel connector; 28-universal wheel; 29-buckle; 30-buckle shaft; 31-driving synchronous wheel; 32-driven synchronous wheel; 33-synchronous belt; 34-intermediate transmission shaft; 35-driven shaft; 36-first driven bevel gear; 37-second driven bevel gear; 38-driving bevel gear; 39-triangular support structure; 40-first drive gear; 41-second drive gear; 42-straight handle end cover; 43-driving shaft; 44-second bearing; 45-third bearing; 46-fourth bearing; 47-fifth bearing; 48-sixth bearing; 49-seventh bearing; 50-driving shaft end retaining ring; 51-second limit retaining ring; 52-limit gear; 53-knob; 54-spring retaining ring; 55-limit handle; 56-limit connecting bar; 57-limit spring; 58-limit optical shaft; 59-third limit retaining ring; 60-fourth limit retaining ring; 61-guide pipe; 62-straight handle end cover outer ring baffle; 63-straight handle end cover inner ring baffle; and 64-laser plane.

### DETAILED DESCRIPTION

The present disclosure will be described in further detail below with reference to the accompanying drawings and specific examples.

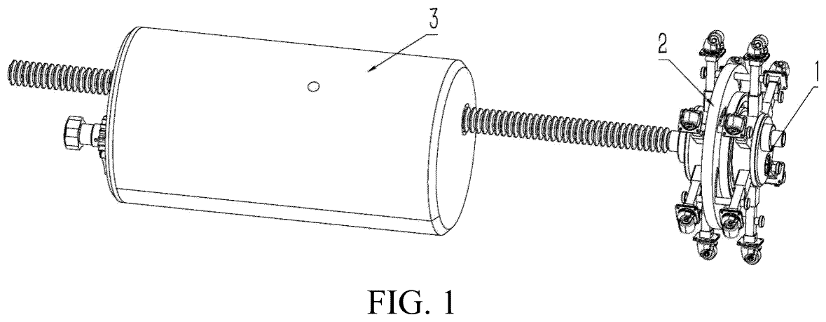

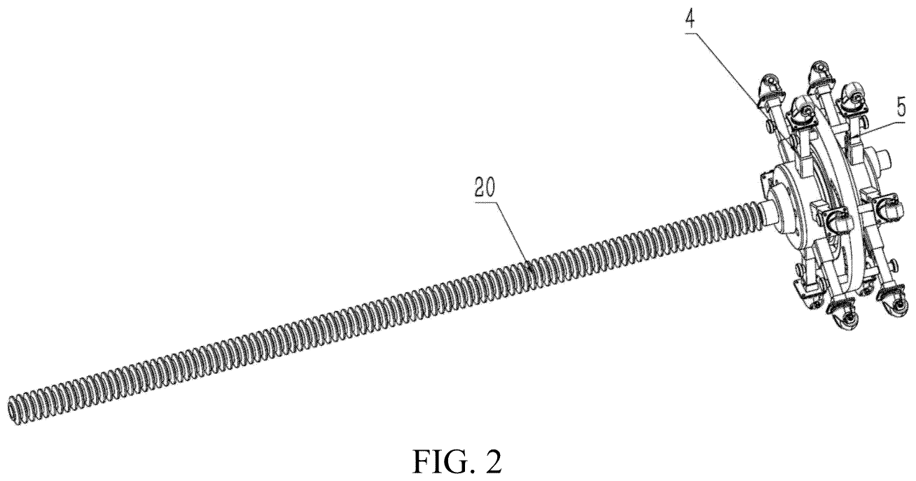

As shown in FIGS. 1 and 2, the present disclosure provides a visual on-line measuring device for inner pipe cross-section distortion during bending of metal pipe with variable diameter, including a visual inspection module 1, a hose 20, an in-pipe support device 2, and an axial feeding device 3. The hose 20 is mounted in the axial feeding device 3, one end of the hose 20 extends out of the axial feeding device 3 and is mounted with the in-pipe support device 2, and the visual inspection module 1 is mounted on a side of the in-pipe support device 2 away from the axial feeding device 3.

The vision inspection module 1 includes a laser 11 and an endoscope 12, the laser 11 and the endoscope 12 are mounted on the side of the in-pipe support device 2 away from the axial feeding device 3 (i.e., on an end face of an inner ring shaft 13 away from the axial feeding device 3) in a threaded manner, and data cables of the laser 11 and the endoscope 12 are led out to an external power interface through the hollow hose 20.

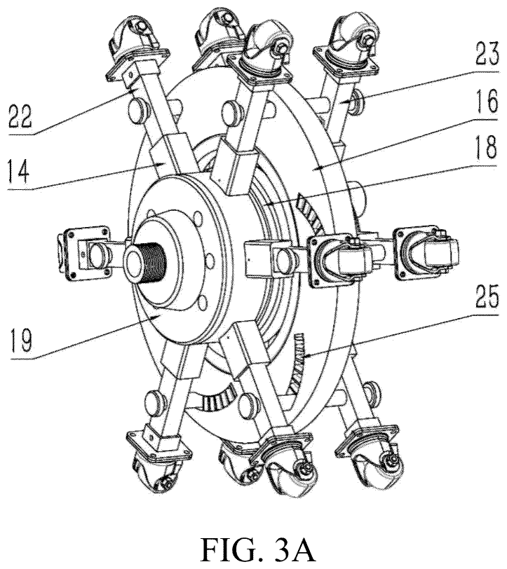

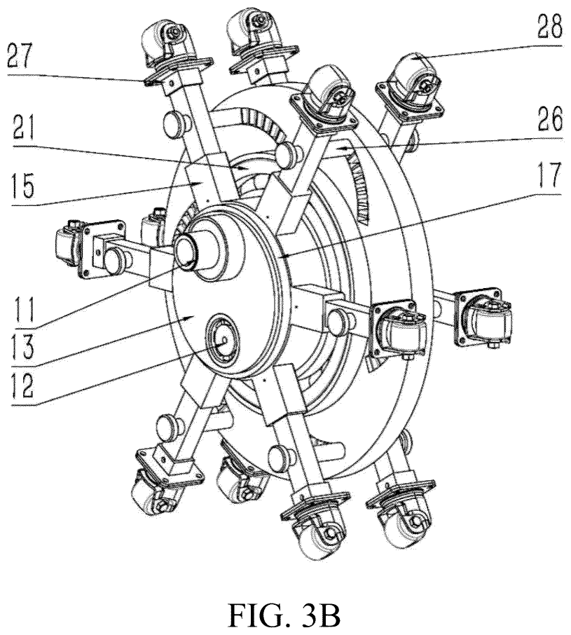

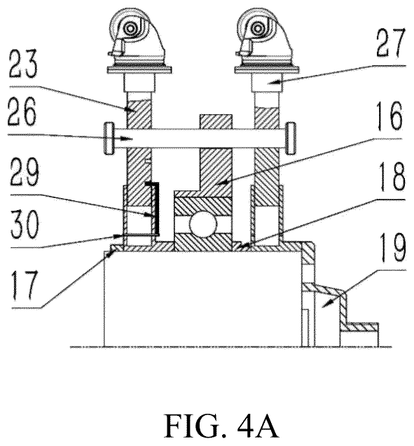

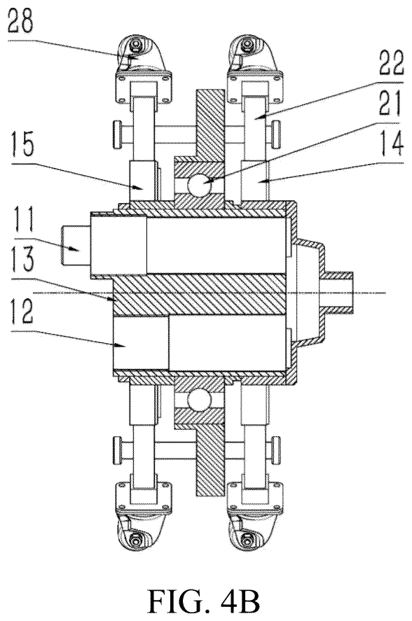

As shown in FIG. 3A, FIG. 3B, FIG. 4A, and FIG. 4B, the in-pipe support device 2 includes a variable-diameter sliding bar mechanism 4 and spring locking mechanisms 5. The variable-diameter sliding bar mechanism 4 is fixedly connected to the one end of the hose 20 extending out of the axial feeding device 3, the laser 11 and the endoscope 12 of the visual inspection module 1 are fixedly mounted on the end face of the inner ring shaft 13 of the variable-diameter sliding bar mechanism 4 away from the axial feeding device 3, and a number of locking sliding bars 23 of the variable-diameter sliding bar mechanism 4 are mounted with corresponding spring locking mechanisms 5.

The variable-diameter sliding bar mechanism 4 includes the inner ring shaft 13, a first sliding block disc 14, a second sliding block disc 15, a cam disc 16, a first limit retaining ring 17, a stepped retaining ring 18, an end cover 19, a first bearing 21, sliding bars 22, a number of locking sliding bars 23, serpentine springs 25, plug pins 26, universal wheel connectors 27, and universal wheels 28. The laser 11 and the endoscope 12 of the visual inspection module 1 are mounted on the end face of the inner ring shaft 13 away from the axial feeding device 3, and the end cover 19 is mounted on an end face of the inner ring shaft 13 close to the axial feeding device 3 for connecting to the one end of the hose 20 extending out of the axial feeding device 3. The cam disc 16 is coaxially sleeved outside a middle part of the inner ring shaft 13 through the first bearing 21, the first sliding block disc 14 and the second sliding block disc 15 are coaxially and fixedly connected to the inner ring shaft 13 on two sides of the cam disc 16, the first sliding block disc 14 is arranged close to the axial feeding device 3, and the second sliding block disc 15 is arranged away from the axial feeding device 3. The stepped retaining ring 18 arranged coaxially is further mounted outside the inner ring shaft 13 between the first sliding block disc 14 and the first bearing 21 for limiting the first sliding block disc 14 and the cam disc 16. A boss end face of the second sliding block disc 15 close to the axial feeding device 3 limits an inner ring of the first bearing 21, and the first limit retaining ring 17 arranged coaxially is mounted at one end away from the axial feeding device 3 for limiting the second sliding block disc 15. A number of sliding bars 22 arranged at intervals along a circumference are mounted on an outer circumferential side face of the first sliding block disc 14, a number of locking sliding bars 23 arranged at intervals along the circumference are mounted on an outer circumferential side face of the second sliding block disc 15, and the corresponding spring locking mechanism 5 is mounted at each locking sliding bar 23. A number of arc-shaped through grooves are disposed on an end face of the cam disc 16, one of the serpentine springs 25 is mounted in each arc-shaped through groove, each plug pin 26 sequentially penetrates through a middle part of the corresponding sliding bar 22 of the first sliding block disc 14, the corresponding arc-shaped through groove of the cam disc 16, and a middle part of the corresponding locking sliding bar 23 of the second sliding block disc 15 in a clearance fit manner. The serpentine springs 25 are fixed between the cam disc 16 and the plug pins 26 by glue, the rotation of the cam disc 16 simultaneously drives all the sliding bars 22 and locking sliding bars 23 to move radially and synchronously, and the first sliding block disc 14 and the second sliding block disc 15 do not rotate relative to the inner ring shaft 13. A corresponding universal wheel 28 is mounted at an end of each sliding bar 22/locking sliding bar 23 through a corresponding universal wheel connector 27.

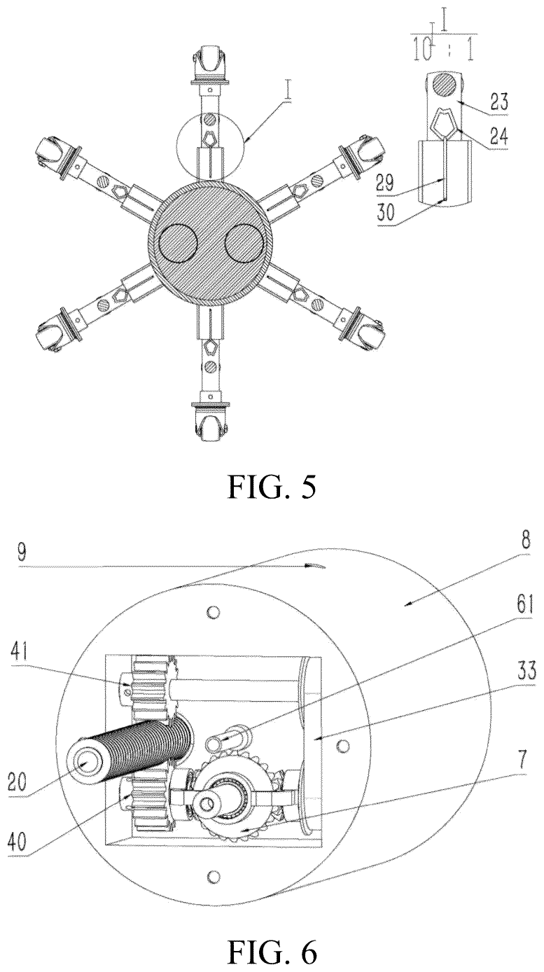

As shown in FIG. 5, the spring locking mechanisms 5 include buckles 29 and buckle shafts 30. A side face of each locking sliding bar 23 is disposed with a locking sliding bar special-shaped sliding groove 24, one end of the buckle 29 is rotatably mounted on an outer circumferential side face of a second sliding block disc 15 in a clearance fit manner, the other end of the buckle 29 is arranged with a boss that is inserted into the locking sliding bar special-shaped sliding groove 24, and realizes guiding sliding along the locking sliding bar special-shaped sliding groove 24. When the buckle 29 is positioned at a bottom of the locking sliding bar special-shaped sliding groove 24, the locking sliding bar 23 is in the maximum variable diameter position, and when the buckle 29 is positioned at a top of the locking sliding bar special-shaped sliding groove 24, each locking sliding bar 23 is in the minimum variable diameter position. The locking sliding bar special-shaped sliding groove 24 is a special-shaped ring groove, a top of an outer edge of the special-shaped ring groove is arranged with an inward protrusion, a top of an inner edge of the special-shaped ring groove is also arranged with an inward protrusion, the protrusion on the top of the outer edge and the protrusion on the top of the inner edge are staggered in a circumferential direction, the buckle 29 is locked by the protrusion on the top of the inner edge when the buckle 29 is located at a top of the special-shaped ring groove, and moves in the special-shaped ring groove according to a preset direction when the buckle 29 is out of a locked state. A middle of a bottom of an inner edge of the special-shaped ring groove is arranged with an upward inclined guide edge, the buckle 29 moves upward along the guide edge, and moves in the special-shaped ring groove according to the preset direction.

The axial feeding device 3 includes a bidirectional limit mechanism 6, a knob 53, an internal gearbox 7 and a straight handle 8. An outer circumferential side face of the straight handle 8 is disposed with a straight handle positioning pin hole 9, a straight handle end cover 42 of the straight handle 8 is further disposed with a straight handle geometric central shaft hole 10, a guide pipe 61 is coaxial with the straight handle geometric central shaft hole 10, and a boss inside the straight handle 8 is connected to the guide pipe 61 in a threaded way. The internal gearbox 7 is mounted in the straight handle 8, the knob 53 is arranged at the straight handle end cover 42 of the straight handle 8, and the knob 53 is coaxially and fixedly connected to a driving shaft 43 of the internal gearbox 7. A first drive gear 40 and a second drive gear 41 of the internal gearbox 7 is connected to the hose 20 for driving the hose 20, and the hose 20 penetrates through the straight handle end cover 42. The bidirectional limit mechanism 6 is mounted on an end face of the straight handle 8 to adjustably limit the knob 53.

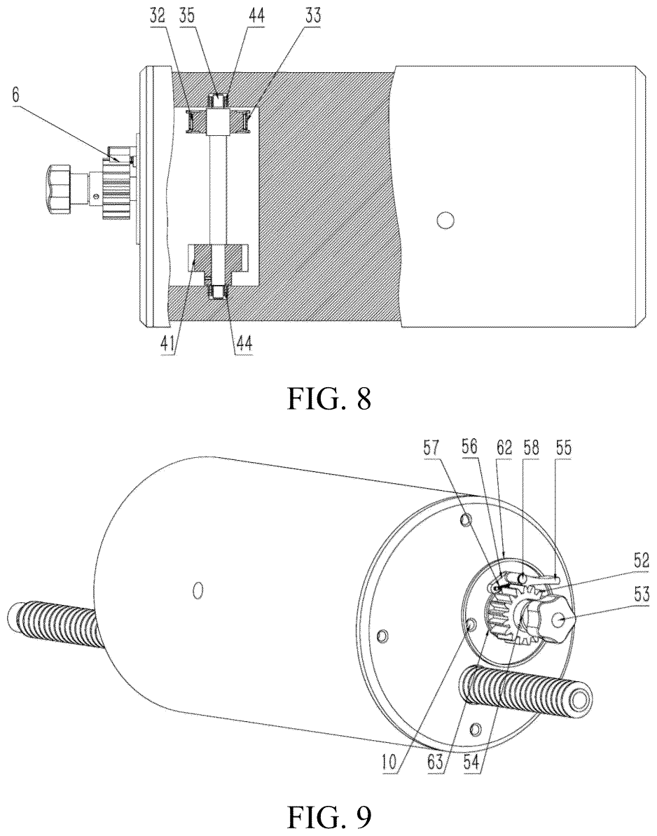

As shown in FIGS. 6, 7A and 8, the internal gearbox 7 includes a driving shaft end retaining ring 50, a third limit retaining ring 59, a fourth limit retaining ring 60, a driving synchronous wheel 31, a driven synchronous wheel 32, a synchronous belt 33, an intermediate transmission shaft 34, a driven shaft 35, a first driven bevel gear 36, a second driven bevel gear 37, a driving bevel gear 38, the first drive gear 40, the second drive gear 41, a driving shaft 43, a second bearing 44, a third bearing 45, and a fourth bearing 46. The guide pipe 61 and the straight handle geometric central shaft hole 10 are arranged coaxially with the straight handle 8, the driving shaft 43 is arranged parallel to the guide pipe 61 and at intervals, the driving shaft 43 is mounted in the straight handle end cover 42 of the straight handle 8 through the fourth bearing 46, and the straight handle end cover 42 at the fourth bearing 46 is further mounted with a second limit retaining ring 51. One end of the driving shaft 43 extends out of the straight handle end cover 42 and is coaxially and fixedly connected to the knob 53, the other end of the driving shaft 43 is coaxially connected to the driving bevel gear 38, and a driving shaft end retaining ring 50 is mounted on an end face of the driving bevel gear 38. The intermediate transmission shaft 34 and the driven shaft 35 are mounted in the straight handle 8, and two ends of the intermediate transmission shaft 34 and two ends of the driven shaft 35 are connected to the side wall of the straight handle 8 through corresponding second bearings 44. The intermediate transmission shaft 34 and the driven shaft 35 are arranged in parallel and at intervals. The driven synchronous wheel 32 and the second drive gear 41 are coaxially sleeved outside the driven shaft 35, and an axial direction of the intermediate transmission shaft 34 is perpendicular to an axial direction of the driving shaft 43. The first driven bevel gear 36 and the second driven bevel gear 37 are coaxially sleeved on the intermediate transmission shaft 34 on two sides of the driving bevel gear 38. The first driven bevel gear 36 and the second driven bevel gear 37 mesh with the driving bevel gear 38 to form a bevel gear pair. The first driven bevel gear 36 is coaxially and fixedly connected to the intermediate transmission shaft 34, and the second driven bevel gear 37 is connected to the intermediate transmission shaft 34 through the third bearing 45. The third limit retaining ring 59 is mounted between the third bearing 45 and the second bearing 44. The first drive gear 40 is coaxially and fixedly connected to the intermediate transmission shaft 34 close to the first driven bevel gear 36, and the fourth limit retaining ring 60 is mounted between the first drive gear 40 and the second bearing 44. The hose 20 is arranged between the first drive gear 40 and the second drive gear 41. Annular teeth are arranged outside the hose 20, and the hose 20 is oppositely meshed with the first drive gear 40 and the second drive gear 41 to form a driving pair. The driving synchronous wheel 31 is coaxially sleeved outside a rotating shaft of the second driven bevel gear 37. The driving synchronous wheel 31 is coaxially and fixedly connected to the rotating shaft of the second driven bevel gear 37, and the driving synchronous wheel 31 is connected to the driven synchronous wheel 32 through the synchronous belt 33. The knob 53 drives the driving shaft 43 to rotate, and the driving synchronous wheel 31 and the intermediate transmission shaft 34 are driven to rotate through the bevel gear pair; the intermediate transmission shaft 34 drives the first drive gear 40 to rotate, and the driving synchronous wheel 31 drives the driven shaft 35 to rotate through the synchronous belt 33 and the driven synchronous wheel 32, thereby driving the second drive gear 41 to rotate, and the first drive gear 40 and the second drive gear 41 jointly drive the hose 20. At this time, the first drive gear 40 and the second drive gear 41 rotate synchronously in the opposite direction to realize the rack-and-pinion feed transmission of the hose 20.

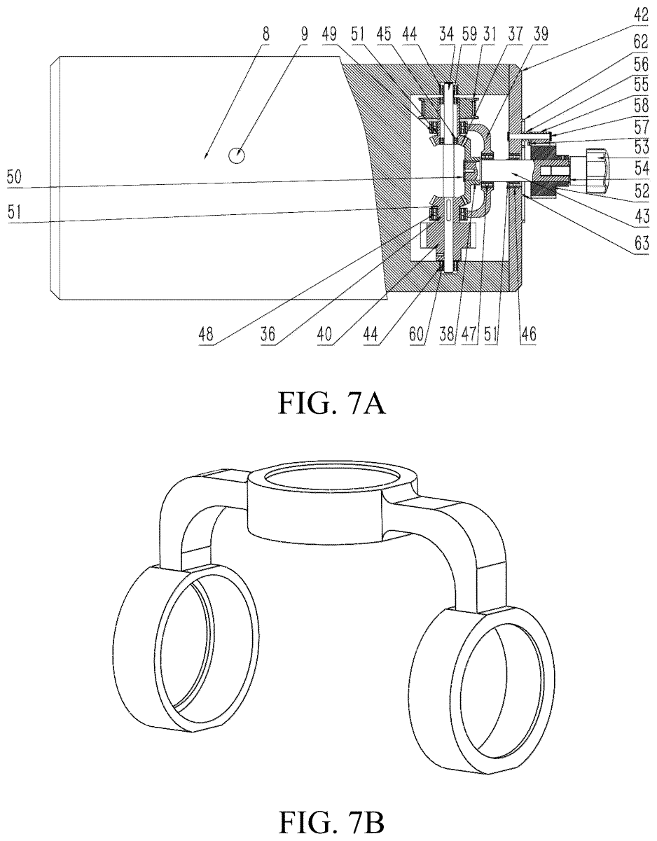

The internal gearbox 7 further includes a triangular support structure 39, the second limit retaining rings 51, a seventh bearing 49, a sixth bearing 48, and a fifth bearing 47. The triangular support structure 39 is mounted between a shaft side of the driving shaft 43 and a shaft side of the first driven bevel gear 36, as shown in FIG. 7B, the triangular support structure 39 is further mounted between the shaft side of the driving shaft 43 and a shaft side of the second driven bevel gear 37, for providing axial and radial support. An annular structure of the triangular support structure 39 close to the driving bevel gear 38 is connected to the shaft side of the driving shaft 43 through the fifth bearing 47, an annular structure of the triangular support structure 39 close to the second driven bevel gear 37 is connected to the shaft side of the second driven bevel gear 37 through the seventh bearing 49, and an annular structure of the triangular support structure 39 close to the first driven bevel gear 36 is connected to the shaft side of the first driven bevel gear 36 through the sixth bearing 48. The second limit retaining ring 51 is further mounted between the sixth bearing 48 and a gear ring of the first driven bevel gear 36, and the second limit retaining ring 51 is further mounted between the seventh bearing 49 and a gear ring of the second driven bevel gear 37. One side of shoulder of the intermediate transmission shaft 34 provides axial positioning for the first driven bevel gear 36. A second limit retaining ring 51 is sleeved on the boss of the first driven bevel gear 36, and the second limit retaining ring 51 is in contact with and provides support for the inner ring of the sixth bearing 48. The outer ring of the sixth bearing 48 is provided with axial and radial support by the triangular support structure 39. One end of the first drive gear 40 provides axial support for the boss end of the first driven bevel gear 36. The boss end of the first drive gear 40 provides axial support for the inner ring of the second bearing 44 through the fourth limit retaining ring 60. The outer ring of the second bearing 44 is provided with radial and axial support by the straight handle 8. The other side of shoulder of the intermediate transmission shaft 34 provides axial support for the inner ring of the third bearing 45 embedded in the end of the second driven bevel gear 37. The outer ring of the third bearing 45 is provided with radial and axial support by the second driven bevel gear 37. The inner ring of the third bearing 45 embedded in the boss end of the second driven bevel gear 37 is provided with axial support by the third limit retaining ring 59. The outer ring of the third bearing 45 is provided with radial and axial support by the second driven bevel gear 37. The other end of the third limit retaining ring 59 provides axial support for the second bearing 44. The outer ring of the second bearing 44 is provided with radial and axial support by the straight handle 8. A second limit retaining ring 51 is sleeved on the boss of the second driven bevel gear 37, and the second limit retaining ring 51 is in contact with and provides support for the inner ring of the seventh bearing 49. The outer ring of the seventh bearing 49 is provided with axial and radial support by the triangular support structure 39.

As shown in FIG. 9, the bidirectional limit mechanism 6 includes a limit gear 52, a spring retaining ring 54, a limit handle 55, a limit connecting bar 56, a limit spring 57 and a limit optical shaft 58. The straight handle end cover 42 is arranged with a straight handle end cover inner ring baffle 63 and a straight handle end cover outer ring baffle 62, the straight handle end cover outer ring baffle 62, the straight handle end cover inner ring baffle 63 and the driving shaft 43 are coaxially arranged, the limit gear 52 is coaxially sleeved outside the driving shaft 43, and the limit gear 52 is coaxially and fixedly connected to the driving shaft 43; the limit optical shaft 58 is fixedly mounted between the straight handle end cover outer ring baffle 62 and the straight handle end cover inner ring baffle 63 of the straight handle end cover 42; one end part of the limit handle 55 and one end part of the limit connecting bar 56 is rotatably mounted in the limit optical shaft 58, and the limit handle 55 and the limit connecting bar 56 are arranged at an included angle; and a toothed end part of the limit handle 55 is connected to the other end part of the limit connecting bar 56 through the limit spring 57, the limit connecting bar 56 is mounted on a circumferential side face of the straight handle end cover inner ring baffle 63, the straight handle end cover inner ring baffle 63 is configured for limiting the limit connecting bar 56, and the limit handle 55 is mounted on a circumferential side face of the limit gear 52 for limiting the limit gear 52. Two ends of the limit spring 57 are hooked inside groove of boss of the limit connecting bar 56 and groove of boss of the limit handle 55, respectively, and provide inward pulling force, so that the limit handle 55 firmly fastens the limit gear 52 and prevents the limit gear 52 from rotating in two directions The knob 53 is fixed to a shaft end of the driving shaft 43 by the spring retaining ring 54.

The in-pipe support device in this disclosure can adapt to the size inside the pipe, thereby adjusting the diameter of the in-pipe support device and locking the in-pipe support device. The straight handle is inserted into a mandrel shaft, when the bidirectional limit mechanism is opened, the knob is rotated to drive the bevel gears in a gearbox, so that the gears at both ends of the hose rotate in reverse, and the axial movement of the endoscope device is realized through gear and rack transmission. The bidirectional limit mechanism is locked during bending to fix the axial position of the visual inspection module and the axial position of the in-pipe support device. A 360-degree laser and endoscope are then used to monitor the shape change of the inner wall cross-section of the pipe during the bending process. The present disclosure has a simple structure and convenient adjustment. Real-time measurement of inner pipe cross-section distortion in a bending forming process of pipes with different diameters can be realized, which provides an on-line solution for pipe bending detection, effectively shortens the trial bending time, and improves production efficiency.

A method for using the visual on-line measuring device for inner pipe cross-section distortion during bending of metal pipe with variable diameter includes the following steps.

In step 1, the in-pipe support device 2 is inserted into a pipe orifice on the side to be bent of the pipe, avoiding deep insertion, and the spring locking mechanisms 5 can be released from the locked state subsequently.

In step 2, the cam disc 16 is rotated manually toward the inner side of the sliding groove, and relative rotation occurs between the cam disc 16 and the second sliding block disc 15. The buckle 29 is disengaged from the top of the special-shaped sliding groove of the locking sliding bar 24 and moves along the sliding groove on the right side, and the variable-diameter sliding bar mechanism 4 is switched to a freely telescopic state. At this time, a thrust force is provided by the serpentine spring 25, and the plug pin 26 is pushed to move toward the outer side of the sliding groove, thereby driving the sliding bar 22 and the locking sliding bar 23 (which are in clearance fit with two ends of the plug pin 26) to move away from the axis. This movement continues until the universal wheels 28 at the top ends of each sliding bar come into contact with the inner wall of the pipe. The arrangement of double-sided sliding bars ensures that the in-pipe support device 2 is not flipped inside the pipe, and the variable-diameter sliding bar mechanism 4 completes the inner diameter self-adaptation process.

In step 3, the axial position of the in-pipe support device 2 is adjusted.

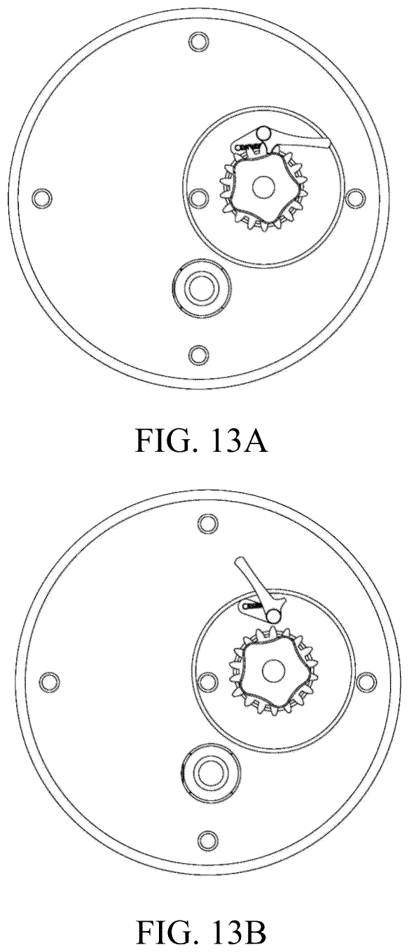

In an initial state, the limit connecting bar 56 is abutted against the straight handle end cover inner ring baffle 63, and the toothed profile of the limit handle 55 is meshed with the limit gear 52. The limit handle 55 of the bidirectional limit mechanism 6 is toggled outward manually. When the boss of the limit handle 55 passes over the plane where the axis of the limit optical shaft 58 and the axis of the boss of the limit connecting bar 56 are coplanar, the limit spring 57 pulls the limit handle 55 and the limit connecting bar 56 outward through tensile force until the limit connecting bar 56 is limited by the straight handle end cover outer ring baffle 62, and the spring is restored to a free state. At this time, the axial feeding device 3 is switched to a free state, as shown in FIG. 13B.

When the knob 53 is rotated clockwise, the driving bevel gear 38 is driven to rotate clockwise by the driving shaft 43, thereby driving the first driven bevel gear 36 and the second driven bevel gear 37 on both sides of the driving bevel gear 38 to rotate in opposite directions, forming coaxial reverse movement. The first drive gear 40 is driven to rotate by the intermediate transmission shaft 34, with a direction consistent with that of the first driven bevel gear 36. The coaxial driving synchronous wheel 31 is driven to rotate in the same direction by the second driven bevel gear 37, and the driven synchronous wheel 32 is driven to move in the same direction by the driving synchronous wheel 31 through belt transmission, thereby driving the coaxial second drive gear 41 to rotate. At this time, the rotation direction of the second drive gear 41 is the same as that of the second driven bevel gear 37 and opposite to that of the first drive gear 40. The first drive gear 40, the second drive gear 41 and the hose 20 are meshed with each other through their tooth profiles and rotate in opposite directions, pushing the hose 20 to move forward, thereby driving the in-pipe support device 2 to feed forward. Similarly, when the knob 53 is rotated counterclockwise, the in-pipe support device 2 is driven to feed backward.

In step 4, after the axial position adjustment of the in-pipe support device 2 is completed, the limit handle 55 of the bidirectional limit mechanism 6 is toggled inward manually, and the tooth profile of the limit handle 55 is meshed with the tooth profile of the limit gear 52, as shown in FIG. 13A. When the boss of the limit handle 55 passes over the plane where the axis of the limit optical shaft 58 and the axis of the boss of the limit connecting bar 56 are coplanar, the limit spring 57 pulls the limit handle 55 and the limit connecting bar 56 inward through tensile force until the limit connecting bar 56 is limited by the straight handle end cover inner ring baffle 63, and the spring is restored to the stretched and locked state. At this time, the axial feeding device 3 is switched to the locked state.

In step 5, the mandrel shaft is inserted into the straight handle geometric central shaft hole 10, passing through the straight handle end cover 42, the guide pipe 61 and the straight handle 8 in sequence. The straight handle positioning pin hole 9 is matched with the positioning pin shaft to limit axial rotation, the pipe is clamped on the pipe bender, and the position of the visual on-line measuring device for inner pipe cross-section distortion inside the pipe is fixed.

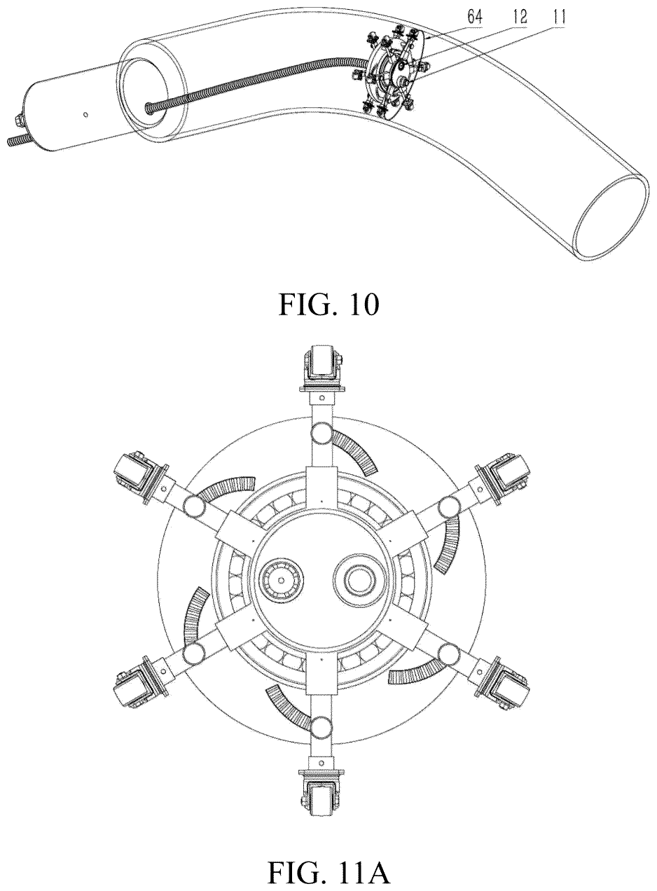

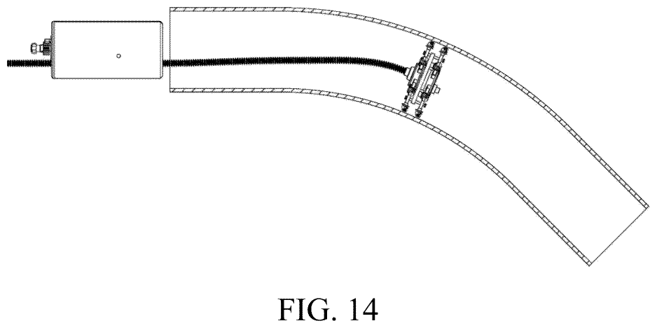

In step 6, as shown in FIG. 10, the power supplies of the laser 11 and the endoscope 12 are turned on. The laser 11 emits a 360-degree laser plane 64 perpendicular to the axial direction, and captures a cross-sectional laser line incident from the inner wall of the tube. At this time, the cross-sectional laser line can be captured in the field of view of the endoscope 12, and the spatial coordinates corresponding to the cross-sectional laser line can be calculated by using the laser triangulation method. When the pipe is bent and deformed, the in-pipe support device 2 rotates with the bending of the pipe, and the visual inspection module 1 detects the cross-sectional information of the laser plane 64 in real time. A schematic diagram of the in-pipe support device in the bent pipe is shown in FIG. 14.

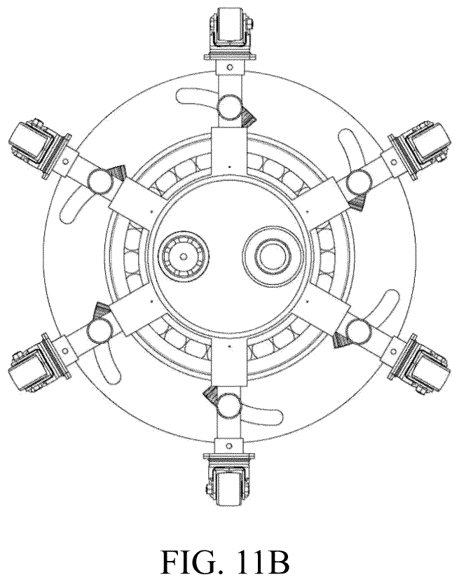

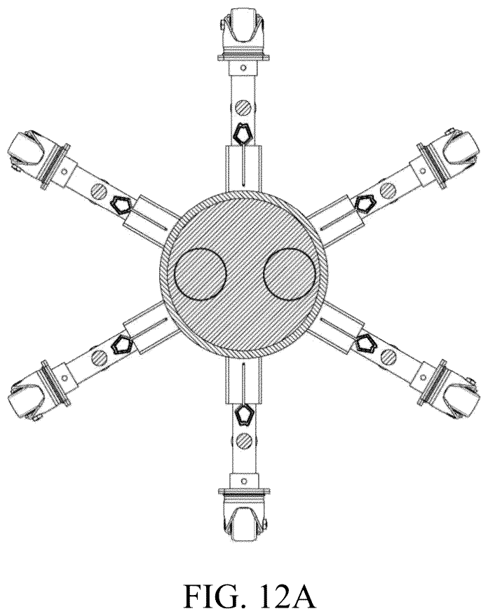

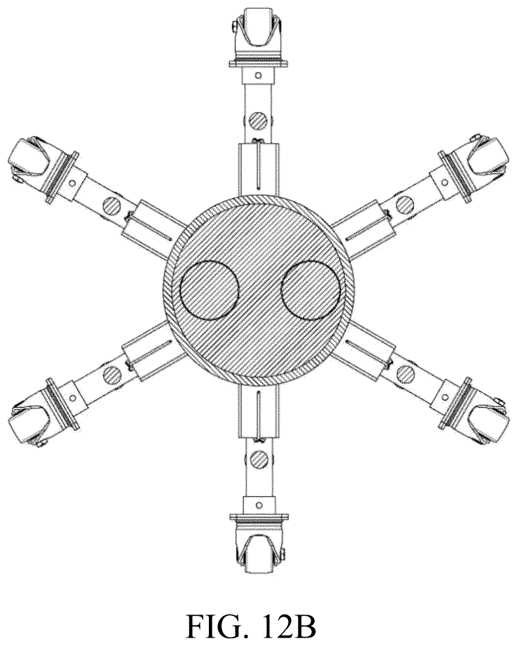

In step 7, after the pipe bending is completed, the power supplies of the laser 11 and the endoscope 12 are turned off. The pipe bender unloads the pipe, and the limit handle 55 of the bidirectional limit mechanism 6 is toggled outward manually, and the axial feeding device 3 is switched to a free state. The knob 53 is rotated counterclockwise to make the in-pipe support device 2 feed backward and withdraw from the pipe. At this time, the variable-diameter sliding bar mechanism 4 reaches the maximum diameter under the thrust of the serpentine spring 25, as shown in FIG. 11A and FIG. 12A, and the buckle 29 is located at the bottom of the locking sliding bar special-shaped sliding groove 24.

In step 8, the straight handle 8 is pulled out from the mandrel rod, the cam disc 16 is rotated manually toward the inner side of the sliding groove, and relative rotation occurs between the cam disc 16 and the second sliding block disc 15. The buckle 29 is disengaged from the bottom of the locking sliding bar special-shaped sliding groove 24 and clamped to the top of the locking sliding bar special-shaped sliding groove 24 along the direction of the left sliding groove. At this time, the variable-diameter sliding bar mechanism 4 is switched to a locked state and reaches the minimum diameter, as shown in FIG. 11B and FIG. 12B. The bidirectional limit mechanism 6 is locked again according to step 4, and the measurement process of inner pipe cross-section distortion during one bending process is completed.

Finally, it is to be noted that the above examples and descriptions are merely for illustrating the technical solutions of the present disclosure and are not limiting. Those ordinary skilled in the art will understand that the technical solutions of the present disclosure can be modified or replaced equivalently without departing from the spirit and scope of the technical solutions of the present disclosure, and all modifications are to be covered within the scope of the claims of the present disclosure.

1. A visual on-line measuring device for inner pipe cross-section distortion during bending of metal pipe with variable diameter, comprising:
a visual inspection module;
a hose;
an in-pipe support device; and
an axial feeding device,
wherein:
the hose is mounted in the axial feeding device, one end of the hose extends out of the axial feeding device and is mounted with the in-pipe support device, and the visual inspection module is mounted at one side of the in-pipe support device away frohe axial feeding device;
the in-pipe support device comprises a variable-diameter sliding bar mechanism and spring locking mechanisms, the variable-diameter sliding bar mechanism is fixedly connected to the one end of the hose extending out of the axial feeding device, the visual inspection module are fixedly mounted on an end face of the variable-diameter sliding bar mechanism away from the axial feeding device, and a plurality of locking sliding bars of the variable-diameter sliding bar mechanism are mounted with corresponding spring locking mechanisms; and
the spring locking mechanisms comprise a buckle; a side face of each locking sliding bar is disposed with a locking sliding bar special-shaped sliding groove, one end of the buckle is rotatably mounted on an outer circumferential side face of a second sliding block disc in a clearance fit manner, the other end of the buckle is arranged with a boss that is inserted into the locking sliding bar special-shaped sliding groove, and realizes guiding sliding along the locking sliding bar special-shaped sliding groove; and in a case that the buckle is positioned at a bottom of the locking sliding bar special-shaped sliding groove, the locking sliding bar is in a maximum variable diameter position, and in a case that the buckle is positioned at a top of the locking sliding bar special-shaped sliding groove, each locking sliding bar is in a minimum variable diameter position.

2. The visual on-line measuring device for inner pipe cross-section distortion during bending of metal pipe with variable diameter according to claim 1, wherein the visual inspection module comprises a laser and an endoscope, the laser and the endoscope are mounted at one side of the in-pipe support device away from the axial feeding device.

3. The visual on-line measuring device for inner pipe cross-section distortion during bending of metal pipe with variable diameter according to claim 1, wherein the variable-diameter sliding bar mechanism comprises an inner ring shaft, a first sliding block disc, a second sliding block disc, a cam disc, a first limit retaining ring, a stepped retaining ring, an end cover, a first bearing, a plurality of sliding bars, the plurality of locking sliding bars, serpentine springs, plug pins, universal wheel connectors, and universal wheels,
wherein the visual inspection module is mounted on an end face of the inner ring shaft away from the axial feeding device, and the one end of the hose extending out of the axial feeding device is connected to an end face of the inner ring shaft close to the axial feeding device; the cam disc is coaxially sleeved outside a middle part of the inner ring shaft through the first bearing, and the first sliding block disc and the second sliding block disc are coaxially and fixedly connected to the inner ring shaft on two sides of the cam disc; the plurality of sliding bars arranged at intervals along a circumference are mounted on an outer circumferential side face of the first sliding block disc, the plurality of locking sliding bars arranged at intervals along the circumference are mounted on an outer circumferential side face of the second sliding block disc, and one of the spring locking mechanisms is mounted at one of the plurality of locking sliding bars; and a plurality of arc-shaped through grooves are disposed on an end face of the cam disc, one of the serpentine springs is mounted in each arc-shaped through groove, each plug pin sequentially penetrates through a middle part of a corresponding sliding bar of the first sliding block disc, a corresponding arc-shaped through groove of the cam disc, and a middle part of a corresponding locking sliding bar of the second sliding block disc, a rotation of the cam disc simultaneously drives all the sliding bars and locking sliding bars to move radially and synchronously, and a corresponding universal wheel is mounted at an end of each sliding bar/locking sliding bar through a corresponding universal wheel connector.

4. The visual on-line measuring device for inner pipe cross-section distortion during bending of metal pipe with variable diameter according to claim 1, wherein the locking sliding bar special-shaped sliding groove is a special-shaped ring groove, a top of an outer edge of the special-shaped ring groove is arranged with an inward protrusion, a top of an inner edge of the special-shaped ring groove is also arranged with an inward protrusion, the protrusion on the top of the outer edge and the protrusion on the top of the inner edge are staggered in a circumferential direction, the buckle is locked by the protrusion on the top of the inner edge in a case that the buckle is located at a top of the special-shaped ring groove, and moves in the special-shaped ring groove according to a preset direction in a case that the buckle is out of a locked state; and a middle of a bottom of the inner edge of the special-shaped ring groove is arranged with an upward inclined guide edge, the buckle moves upward along the guide edge, and moves in the special-shaped ring groove according to the preset direction.

5. The visual on-line measuring device for inner pipe cross-section distortion during bending of metal pipe with variable diameter according to claim 1, wherein the axial feeding device comprises a bidirectional limit mechanism, a knob, an internal gearbox and a straight handle,
wherein the internal gearbox is mounted in the straight handle, the knob is arranged at a straight handle end cover of the straight handle, and the knob is coaxially and fixedly connected to a driving shaft of the internal gearbox; the internal gearbox is connected to the hose for driving the hose; and the bidirectional limit mechanism is mounted on an end face of the straight handle to adjustably limit the knob.

6. The visual on-line measuring device for inner pipe cross-section distortion during bending of metal pipe with variable diameter according to claim 5, wherein the internal gearbox comprises a driving synchronous wheel, a driven synchronous wheel, a synchronous belt, an intermediate transmission shaft, a driven shaft, a first driven bevel gear, a second driven bevel gear, a driving bevel gear, a first drive gear, a second drive gear, the driving shaft, a second bearing, a third bearing, and a fourth bearing,
wherein the driving shaft is mounted in the straight handle end cover of the straight handle through the fourth bearing, one end of the driving shaft extends out of the straight handle end cover and is coaxially and fixedly connected to the knob, and the other end of the driving shaft is coaxially connected to the driving bevel gear; the intermediate transmission shaft and the driven shaft are arranged in the straight handle, the intermediate transmission shaft and the driven shaft are arranged in parallel and at intervals, the driven synchronous wheel and the second drive gear are coaxially sleeved outside the driven shaft, and an axial direction of the intermediate transmission shaft is arranged vertically with an axial direction of the driving shaft; the first driven bevel gear and the second driven bevel gear are coaxially sleeved at the intermediate transmission shaft on two sides of the driving bevel gear, respectively, the first driven bevel gear and the second driven bevel gear are both meshed with the driving bevel gear to form a bevel gear pair, the first driven bevel gear is coaxially and fixedly connected to the intermediate transmission shaft, and the second driven bevel gear is connected to the intermediate transmission shaft through the third bearing; the first drive gear is coaxially and fixedly connected to the intermediate transmission shaft close to the first driven bevel gear; the hose is arranged between the first drive gear and the second drive gear, annular teeth are arranged outside the hose, and the hose is oppositely meshed with the first drive gear and the second drive gear to form a driving pair; and the driving synchronous wheel is coaxially sleeved outside a rotating shaft of the second driven bevel gear, the driving synchronous wheel is coaxially and fixedly connected to the rotating shaft of the second driven bevel gear, and the driving synchronous wheel is connected to the driven synchronous wheel through the synchronous belt.

7. The visual on-line measuring device for inner pipe cross-section distortion during bending of metal pipe with variable diameter according to claim 6, wherein the internal gearbox further comprises a triangular support structure, a seventh bearing, a sixth bearing and a fifth bearing,
wherein the triangular support structure is mounted between a shaft side of the driving shaft and a shaft side of the first driven bevel gear, and the triangular support structure is further mounted between the shaft side of the driving shaft and a shaft side of the second driven bevel gear; and an annular structure of the triangular support structure close to the driving bevel gear is connected to the shaft side of the driving shaft through the fifth bearing, an annular structure of the triangular support structure close to the second driven bevel gear is connected to the shaft side of the second driven bevel gear through the seventh bearing, and an annular structure of the triangular support structure close to the first driven bevel gear is connected to the shaft side of the first driven bevel gear through the sixth bearing.

8. The visual on-line measuring device for inner pipe cross-section distortion during bending of metal pipe with variable diameter according to claim 5, wherein the bidirectional limit mechanism comprises a limit gear, a limit handle, a limit connecting bar, a limit spring and a limit optical shaft,
wherein the straight handle end cover is arranged with a straight handle end cover inner ring baffle and a straight handle end cover outer ring baffle, the limit gear is coaxially sleeved outside the driving shaft, and the limit gear is coaxially and fixedly connected to the driving shaft; the straight handle end cover is fixedly mounted with the limit optical shaft, one end part of the limit handle and one end part of the limit connecting bar is rotatably mounted in the limit optical shaft, and the limit handle and the limit connecting bar are arranged at an included angle; and a toothed end part of the limit handle is connected to the other end part of the limit connecting bar through the limit spring, the limit connecting bar is mounted on a circumferential side face of the straight handle end cover inner ring baffle, the straight handle end cover inner ring baffle is configured for limiting the limit connecting bar, and the limit handle is mounted on a circumferential side face of the limit gear for limiting the limit gear.
